(19) United States
(12) Patent Application Publication
(10) Pub. No.: US 2026/0064812 A1
(43) Pub. Date: Mar. 5, 2026

(54) METHOD AND ASSEMBLY FOR CALIBRATING ONE OR MORE SENSORS OF A SENSOR SUPPORT

(71) Applicant: Continental Autonomous Mobility Germany GmbH, Ingolstadt (DE)

(72) Inventors: Roman Streubel, Bodolz (DE); Ingrid Tigges, Taunusstein (DE); Urban Meis, Göppingen (DE)

(73) Assignee: Continental Autonomous Mobility Germany GmbH, Ingolstadt (DE)

(21) Appl. No.: 19/120,909

(22) PCT Filed: Sep. 22, 2023
(86) PCT No.: PCT/DE2023/200198

§ 371 Date: Apr. 14, 2025

(30) Foreign Application Priority Data
Oct. 17, 2022 (DE) 10 2022 210 941.4

(51) Int. Cl. G06F 18/2413; G01D 18/00; G01S 7/40

(52) U.S. Cl. CPC G06F 18/24147; G01D 18/00; G01S 7/4021

(57) ABSTRACT

The embodiments relate to an assembly for calibrating one or more sensors, of a sensor carrier consisting of a plurality of elements which are arranged at specified three-dimensional positions in a specified pattern, wherein the three-dimensional positions are known a priori, wherein each element can be uniquely identified, wherein the elements are arranged at a specified three-dimensional distance to one another, and wherein the distances are known from the three-dimensional positions of the elements which are known a priori.

### TECHNICAL FIELD

The embodiments relate to a method and an assembly for sensor calibration for sensors of a sensor carrier.

### BACKGROUND

Moving individual calibration elements, for example by means of robots, around a vehicle in order to be able to calibrate all sensors of said vehicle is known from the prior art. Methods are also known in which the vehicle is arranged on a rotating platform and different stationary patterns are detected during the rotation of the platform in order to calibrate all sensors. Moving a vehicle through stationary elements by means of a moving platform at the end of the production line is also known.

All of these are time-consuming and expensive. Furthermore, the known methods are only suitable for overlapping and partially overlapping fields of view (FoVs).

### SUMMARY

It is the object to provide an assembly as well as a method by means of which a sensor calibration of vehicles can be carried out in a manner which is not time-consuming and is precise and accurate.

Initial considerations related to the issue that the known methods are not suitable for calibrating multiple sensors without overlapping fields of view.

An assembly is proposed for calibrating one or more sensors of a sensor carrier consisting of a plurality of elements which are arranged at specified three-dimensional positions in a specified pattern, wherein the three-dimensional positions are known a priori, wherein each element can be uniquely identified, wherein the elements are arranged at a specified three-dimensional distance to one another, and wherein the distances between the elements are known from the three-dimensional positions which are known a priori.

Here, the sensor carrier can be statically or dynamically configured. A dynamic sensor carrier can be, for example, a vehicle, e.g., a passenger car or a truck. It is further conceivable for the dynamic sensor carrier to be a robot, an airplane, a drone or another dynamic object which can be equipped with sensors. Static sensor carriers such as, for example, infrastructure elements such as bridges or traffic lights on which sensors can be arranged are also conceivable. The assembly can correspondingly be used for both sensor carrier types. For static sensor carriers, the assembly can be arranged in at least a part of the field of view of the one or more sensors in order to allow for steady calibration and to identify changes in the sensors, for example due to weather conditions.

In a configuration, each of the elements can be uniquely identified via its n-closest neighbor. Depending on the field of view of the respective sensors, different or a different number of elements are detected. With the assembly and the known three-dimensional distances among the elements, it can be uniquely determined which elements are recorded by the respective sensor and the expected position can, for example in a camera image, be compared with the recorded position. The alignment and calibration of the sensors in relation to one another can also be checked, because, through the known pattern with the known three-dimensional positions of the elements and with the respective three-dimensional distances between the elements, it can be correspondingly checked if the part of the pattern recorded by the respective sensor is correctly shown and if the relations of the recorded elements to one another are correct. The fields of view of the sensors need not overlap in this case. It is enough for the respective sensors to record only a part of the pattern. With this assembly, it is also possible for the calibration to be performed while driving through the assembly or driving past the assembly, because it is sufficient for the sensors to only have to record a part of the assembly and the fields of view need not overlap with one another.

Further, for identification of the n-closest neighbor may be performable via a Delaunay triangulation for identifying the closest elements.

In a further configuration, each element has an identification feature. The identification in this case is based on the position of the respective element as well as the distances to the n-closest neighbors. Respective internal angles are determined using the distances to the n-closest neighbors. These internal angles can be defined as identification features of the elements, because each internal angle can be uniquely associated with a specified element of the assembly.

Further, a method is proposed for calibrating one or more sensors of a sensor carrier through recording an assembly, the method comprising the following steps:
detecting at least a part of the assembly by at least one or more sensors of a sensor carrier;
detecting the respective distances of the elements in the respective field of view of the one or more sensors and identifying the elements;
   performing the calibration based on the respective three-dimensional positions of the detected elements of the assembly.

Three-dimensional positions of the elements can also be determined from the distances between the detected elements.

In an embodiment, a distance to the n-closest neighbor of an element is examined for calibration. By examining the n-closest neighbor, each element can be uniquely identified. The distance can, for example, be determined at the image level. At the image level, this would be a two-dimensional distance.

Further, a Delaunay triangulation is performed for calculating the distance to the n-closest neighbor of an element. The Delaunay triangulation can, for example, be performed by means of the Bowyer-Watson algorithm.

If multiple sensors are used, all sensors of the sensor carrier are individually or collectively calibrated. This is made possible through the assembly and the set distances of the elements to one another. With multiple sensors, they need not have overlapping fields of view and need not detect the same elements. Depending on the number and assembly of the sensors in or on the sensor carrier, the assembly of the elements can also be adapted correspondingly, such that each sensor can detect at least a partial region of the assembly.

In a further configuration, ground truth data are determined from the assembly of the elements. In the assembly, the three-dimensional positions of the elements are known a priori. From this, the three-dimensional distances to the closest elements can be determined. The three-dimensional position of each individual element is already ground truth.

Further, the calibration may be performed statically or dynamically. For a dynamic calibration, the sensor carrier moves past the assembly or through the assembly and records the respective elements during the movement. Aside from extrinsic sensor calibration, in this case, it is also possible to estimate the ego movement of the sensor carrier. Based on the ego movement, further sensors, such as, for example, a wheel rotation speed sensor and/or a rotation rate sensor of a vehicle, can then be calibrated.

### BRIEF DESCRIPTION OF THE DRAWINGS

Further configurations are the subject-matter of the figures. Therein:

FIG. 1: shows a schematic representation of an assembly with a vehicle with sensors to be calibrated according to an embodiment;

FIG. 2a: shows a schematic representation of an element with the closest neighbors according to an embodiment;

FIG. 2b: shows a further schematic representation of an element with the closest neighbors according to a further embodiment;

FIG. 3: shows a schematic flowchart of a method according to an embodiment.

### DETAILED DESCRIPTION

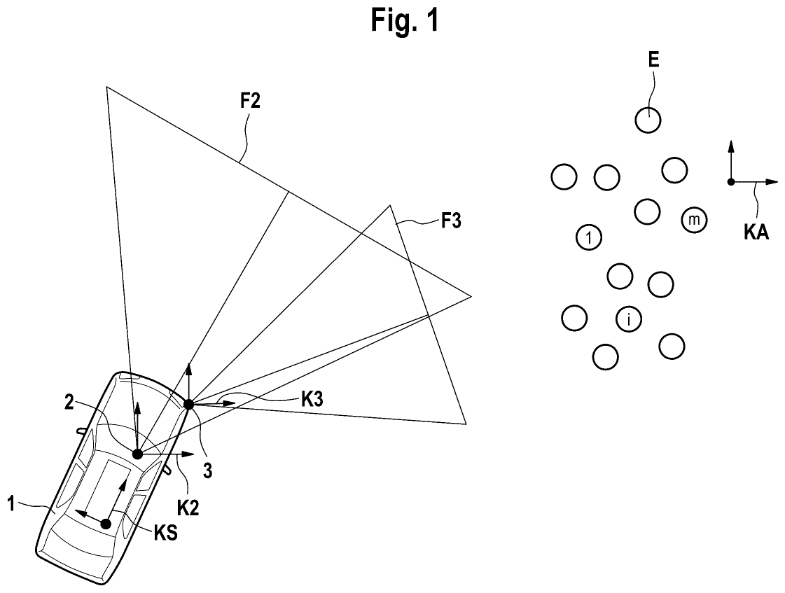

FIG. 1 shows a schematic representation of an assembly with a vehicle configured as a sensor carrier 1 with sensors 2, 3 to be calibrated according to an embodiment. The assembly consists of multiple individual elements E (E1-Ei, Em) which are arranged in a specified pattern. The vehicle 1 records the assembly with the sensors 2, 3. Each sensor 2, 3 has a field of view F2, F3 such that other or fewer elements E of the assembly are recorded by the sensor 2 than by the sensor 3. The sensor 2 can be, for example, a camera and the sensor 3 can be a corner radar. The arrangement could also be recorded by the vehicle 1 driving past the sensor 2, 3 and the sensors could be calibrated correspondingly. The embodiments are not limited to two sensors, but is instead suitable for a plurality of sensors as well as for single-sensor calibration. The sensor carrier 1 or the vehicle, the respective sensors 2, 3, and the assembly each have a coordinate system KA, KS, K2 or K3.

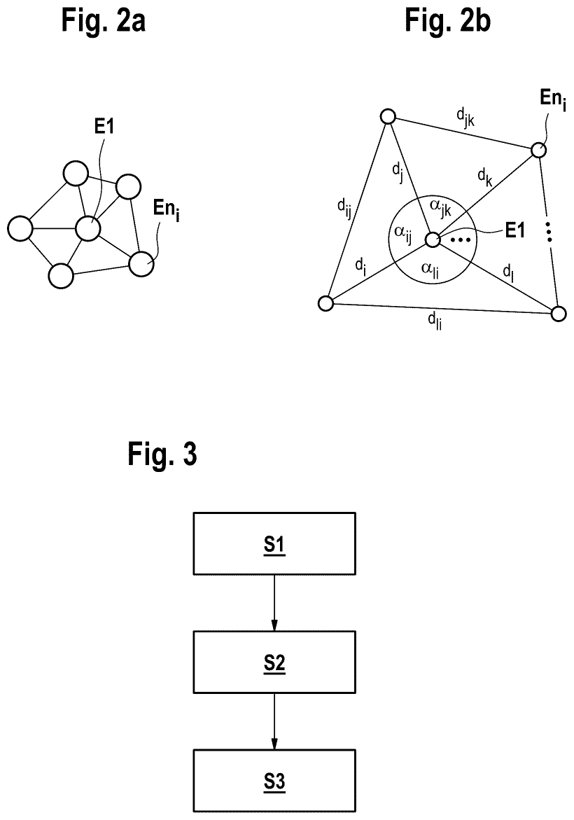

FIG. 2a shows a schematic representation of an element E1 with the closest neighbors Enᵢ according to an embodiment. The element E1 can be uniquely identified by the respective closest neighbors Eni of the element E1, because each element E has a specified number of closest neighbors Eni with a defined distance. This is determined by the pattern. Likewise, the respective three-dimensional positions of the elements E are known a priori. The distances d between the elements E can be determined from the positions of the elements E.

FIG. 2b shows a further schematic representation of an element E1 with the closest neighbors Eni according to a further embodiment. This representation shows how the identification of the closest neighbor Enᵢ is performed by means of Delaunay triangulation. By means of Delaunay triangulation, a triangle mesh is created from a set of points Enᵢ and E1.

FIG. 3 shows a schematic flowchart of a method according to an embodiment. In step S1, at least a part of the assembly is detected by at least one or more sensors 2, 3 of a sensor carrier. In step S2, the respective distances of the elements E1-Em are detected in the respective field of view F2, F3 of the one or more sensors 2, 3 and the elements E1-Em are identified. In step S3, the calibration is performed based on the respective three-dimensional positions of the detected and identified elements of the assembly.

1. An assembly for calibrating at least one sensor of a sensor carrier comprising:
a plurality of elements which are arranged at specified three-dimensional positions in a specified pattern, wherein the three-dimensional positions are known a priori,
wherein each element can be uniquely identified,
wherein the elements are arranged at a specified three-dimensional distance to one another, and
wherein the distances are known from the three-dimensional positions of the elements which are known a priori.

2. The assembly according to claim 1, wherein each of the elements can be uniquely identified via its n-closest neighbor.

3. The assembly according to claim 2, wherein the identification of the n-closest neighbor carried out by Delaunay triangulation.

4. The assembly according to claim 1, wherein each element has at least one identification feature.

5. A method for calibrating at least one sensor of a sensor carrier comprising
recording an assembly comprising:
a plurality of elements which are arranged at specified three-dimensional positions in a specified pattern, wherein the three-dimensional positions are known a priori:
wherein each element can be uniquely identified:
wherein the elements are arranged at a specified three-dimensional distance to one another; and
wherein the distances are known from the three-dimensional positions of the elements which are known a priori:
detecting at least a part of the assembly by the at least one sensor of the sensor carrier;
detecting the respective distances of the elements in the respective field of view of the sensor at least one sensor and identifying at least one element of the plurality of elements; and
performing the calibration based on the respective three-dimensional positions of the detected and identified elements of the assembly.

6. The method according to claim 5, further comprising examining a distance to the n-closest neighbor of an element for calibration.

7. The method according to claim 6, further comprising performing a Delaunay triangulation for calculating the distance to the n-closest neighbor of an element of the plurality of elements.

8. The method according to claim 5, wherein the at least one sensor is multiple sensors and calibrating individually and/or collectively the multiple sensors.

9. The method according to claim 5, further comprising determining ground truth data from the assembly.

10. The method according to claim 5, further comprising performing the calibration statically or dynamically.
